(19) United States
(12) Patent Application Publication
(10) Pub. No.: US 2021/0307294 A1
(43) Pub. Date: Oct. 7, 2021

(54) INTERCHANGEABLE DOUBLE-SIDED ATTACHMENT FOR PET LEASH AND COLLAR

(71) Applicant: Richard Anthony KIMBEL, Pasadena, CA (US)

(72) Inventor: Richard Anthony KIMBEL, Pasadena, CA (US)

(21) Appl. No.: 17/067,473

(22) Filed: Oct. 9, 2020

Related U.S. Application Data
(60) Provisional application No. 63/004,489, filed on Apr. 2, 2020.

(51) Int. Cl. A01K 27/00

(52) U.S. Cl. CPC A01K 27/001; A01K 27/005; A01K 27/006; A01K 27/003

(57) ABSTRACT

Provided in the disclosure are durable, and washable, double-sided pet collar attachments. These pet collar attachments can be removably attached to pet collars. Each side of the pet collar attachments can have different designs. In this manner, the pet collars can be provided with a multitude of designs.

### CROSS-REFERENCE TO RELATED APPLICATIONS

This patent document claims priorities to and benefits of U.S. Provisional Patent Application No. 63/004,489, filed on Apr. 2, 2020. The entire content of the aforementioned patent application is incorporated by reference as part of the disclosure of this patent document.

### TECHNICAL FIELD

Various embodiments of the present disclosure generally relate to pet collars and their removable attachments.

### BACKGROUND

Dog owners typically want to provide multiple dog collars for their dogs. Owners may want to provide decorative collars, or collars that provide a certain function, e.g., reflective collars for late night walks. Providing numerous collars, however, gets very costly. Further, having to replace and manage collars can become cumbersome. In addition, having to have multiple different collars becomes difficult to clean and maintain. Certain parts of collars degrade with usage and washing.

What is needed is a practical, usable, and economical pet collar and removable attachment.

### SUMMARY

This document relates to methods, systems, and devices for a double-sided attachment for a pet collar.

In an aspect, the attachment has a piece of a first material, the piece of the first material being substantially the same size as the size of a second material, the first material having a first side that has a first design, a first attachment mechanism provided on one end of the first side of the piece of first material, and a second attachment mechanism provided on the other end of the first side of the piece of the first material, wherein the first attachment mechanism and the second attachment mechanism are configured to allow the first material to be removably attached to the second material.

In yet another aspect, the attachment has a second side on the first material, the second side having a second design, a third attachment mechanism provided on one end of the second side of the first material, and a fourth attachment mechanism provided on the other end of the second side of the first material, wherein the third attachment mechanism and the fourth attachment mechanism are configured to allow the first material to be removably attached to the second material.

In yet another aspect, the second material is a dog collar. In yet another aspect, the second material is a dog leash. In yet another aspect, the first design is a reflector. In yet another aspect, the first design and the second design are sports team logos. In yet another aspect, the material comprises synthetic materials. In yet another aspect, the material comprises faux stitching. In yet another aspect, the first, second, third, and fourth attachment mechanisms are metal clips. In yet another aspect, the first, second, third, and fourth attachment mechanisms are plastic clips. In yet another aspect, the material comprises faux stitching. In yet another aspect, the first, second, third, and fourth attachment mechanisms are a hook or loop system.

In an aspect, a pet collar is provided with a material, the material having attachment mechanisms on each end, the attachment mechanism being configured to removably attach to each other, a first attachment mechanism on one end of the material, a second attachment mechanism on the other end of the material, wherein the first and second attachment mechanism are configured to receive an attachment, the attachment being removably attachable.

In yet another aspect, the attachment further comprises a third attachment mechanism on one end of the attachment and a fourth attachment mechanism on the other end of the attachment, the attachment's third and fourth attachment mechanism being configured to be removably attached to the first attachment mechanism and the second attachment mechanism, the attachment having a first design.

In yet another aspect, attachment further comprises a fifth attachment mechanism on one end of the attachment and a sixth attachment mechanism on the other end of the attachment, the fifth and sixth attachment mechanism being placed on the other side of the third and fourth attachment mechanism, the attachment's fifth and sixth attachment mechanism being configured to be removably attached to the first attachment mechanism and the second attachment mechanism, the attachment having a second design. In yet another aspect, the first design is a reflector. In yet another aspect, the second design is a reflector. In yet another aspect, the first design and the second design are sports team logos. In yet another aspect, the attachment is made of synthetic materials. In yet another aspect, the attachment comprises faux stitching. In yet another aspect, the first, second, third, fourth, fifth, and sixth button attachment mechanisms are metal or plastic clips. In yet another aspect, the first, second, third, fourth, fifth, and sixth button clips are a hook and loop system.

As will be realized, embodiments of the disclosure are capable of modifications in various aspects, all without departing from the scope of the present disclosure. Accordingly, the drawings and detailed description are to be regarded as illustrative in nature and not restrictive.

### BRIEF DESCRIPTION OF THE DRAWINGS

The present disclosure provides a double-sided attachment, with a plurality of designs, for pet accessories.

FIG. 1 illustrates a dog collar 100.

FIG. 2 illustrates a dog collar attachment 200.

FIG. 3 illustrates a view of the dog collar attachment 300.

FIG. 4 illustrates a dog collar with a dog collar attachment 400.

FIG. 5 illustrates a dog leash 500.

FIG. 6 illustrates a double-sided attachment for the dog leash

FIG. 7 illustrates a dog leash of FIG. 5 shown with the double-sided attachment of FIG. 6

FIG. 8 illustrates a dog collar attachment 800 using a hook and loop system.

While embodiments of the present disclosure are amenable to various modifications and alternative forms, specific embodiments have been shown by way of example in the drawings and are described in detail below. The intention, however, is not to limit the disclosure to the particular embodiments described. On the contrary, the disclosure is intended to cover all modifications, equivalents, and alternatives falling within the scope of the disclosure as defined by the appended claims.

### DETAILED DESCRIPTION

The present disclosure claims priority to U.S. App. No. 63/004,489, the contents of which are incorporated by reference in their entirety.

The present disclosure relates to dog collar attachments. More specifically, it relates to double sided decorative collar attachments that can be removably attached to pet collars. The pet collar attachments can be configured with designs on each side, so that the pet collar attachments can be configured to display different designs.

In an embodiment, the dog collar attachments are made of synthetic materials. In another embodiment, the dog collar attachments have faux stitching. The dog collar attachments (and the collar they can be removably attachable to) are machine washable, making them more practical for long-term use.

In an embodiment, the dog collar attachments are made to have different designs on each of their sides. To accomplish this, attachment mechanisms are provided on distal portions of the dog collar attachment. This allows both sides of the dog collar attachment to have designs. The attachment mechanisms can be a hook and loop system (VELCRO), button clips, or magnetic attachments.

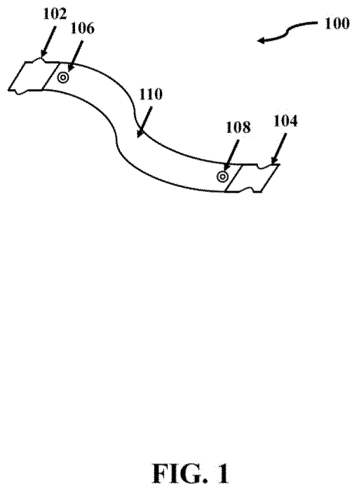

FIG. 1 illustrates a dog collar 100. The dog collar 100 has clip attachment portions 102 and 104 attached to a collar portion 110. The collar portion 110 is bendable, and made of a synthetic fabric or cloth. The clip attachment portions 102 and 104 are configured so that they clip onto each other.

In an embodiment, the attachment 102 and 104 are made of plastic or metal. In another embodiment, the attachments 102 and 104 are a buckle system. It should further be understood that the clip attachments can be any attachment mechanism known in the art.

The collar portion 110 is configured with clip buttons 106 and 108. The clip buttons 106 and 108 are configured to receive removably attachable items. In an embodiment, the clip buttons are made of plastic. In another embodiment, the clip buttons are made of metal.

Because the dog collar 100 is made of durable and washable materials, it can be washed. Even through numerous wash cycles, dog collar will still function well because it has stronger clip buttons.

In an embodiment, the dog collar 100 has a loop to attach a leash to.

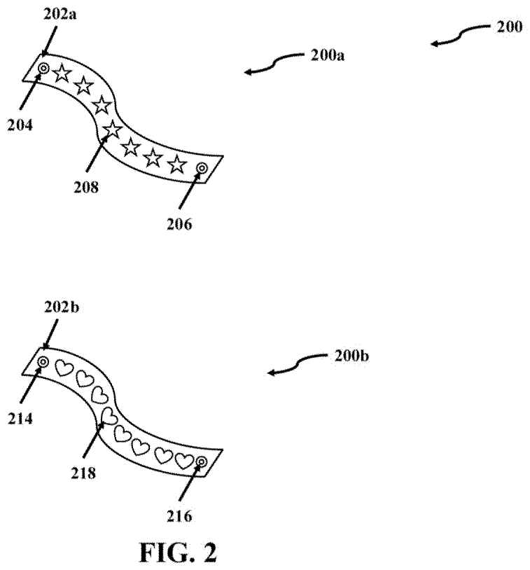

FIG. 2 illustrates a dog collar attachment 200. The dog collar attachment 200 is configured to be two-sided. Shown in 200a is a first side and shown in 200a is the second side.

In an embodiment, the dog collar attachment 200 is single sided.

Shown on the first side 200a is a side 202a having a particular design, e.g., stars 208. Attached to side 202a are clip buttons 204 and 206. The clip buttons 204 and 206 are configured so that they can be removably attached to the dog collar 100 shown in FIG. 1. In an embodiment, clip buttons 204 and 206 are made of plastic. In another embodiment, clip buttons 204 and 206 are made of metal.

Shown in the second side 200b, is a side 202b having a different design, e.g., hearts 218. Attached to side 202b are clip buttons 214 and 216. The clip buttons 214 and 216 are configured so that they can be removably attached to the dog collar 100 shown in FIG. 1. In an embodiment, clip buttons 214 and 216 are made of plastic. In another embodiment, clip buttons 214 and 216 are made of metal.

In an embodiment, the dog collar 100 of FIG. 1 and the dog collar attachment 200 of FIG. 2 are aligned so that there is no exposed material of the dog dollar when buttons 204 and 206 (or 214 and 216) of FIG. 2 are attached to buttons 106 and 108 of FIG. 1.

As should be appreciated, when clip buttons 204 and 206 are attached to the dog collar 100 shown in FIG. 1, side 202a is placed downwards and stars 208 are hidden. In this configuration, side 202b is revealed, and hearts 218 are displayed.

Conversely, when clip buttons 214 and 216 are attached to the dog collar 100 shown in FIG. 1, side 202b is placed downwards and hearts 218 are hidden. In this configuration, side 202a is revealed, and stars 208 are displayed.

Stars 208 and hearts 218 are merely exemplary designs. It should be understood that any type of designs can be used. For instance, certain designs can be of sports team logos. Further, the designs can have reflectors, or lights like LEDs, or fiber optics, or any different type of texturing and materials.

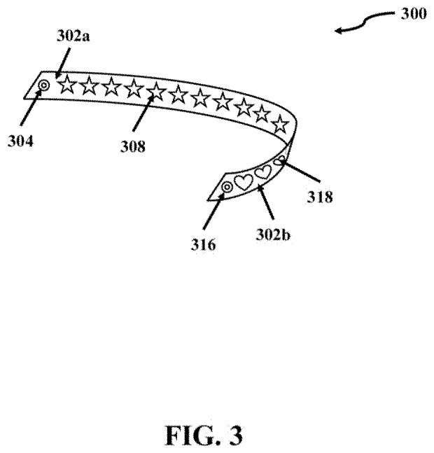

Shown in FIG. 3 is another view of the dog collar attachment 300 where both sides are shown. The dog collar attachment 300 has a first side 302a and a design, e.g., stars 308. The first side 302a has a button clip 304. Not shown in the figure (because it is blocked from view) is the first side 302a's other button clip. The second side 302b has another design, e.g., hearts 318, along with a button clip 316. Not shown in the figure (because it is blocked from view) is the second side 302b's other button clip.

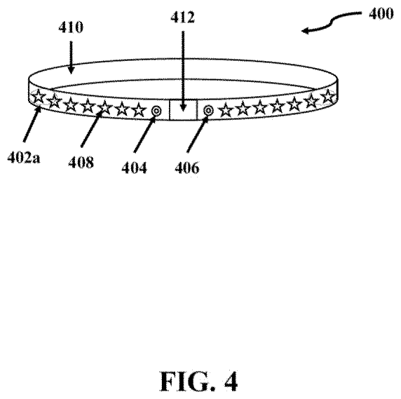

Shown in FIG. 4 is a dog collar with a dog collar attachment 400. The dog collar attachment is shown removably attached to the dog collar 410, which is connected via the dog collar latch 412. As can be seen, the dog collar attachment is shown with its first side 402a up, displaying stars 408. The outer buttons 404 and 406 are displayed, but it should be understood that the inner buttons are affixed to the dog collar 410.

In an embodiment, the dog collar 410 has a loop to attach a leash to.

It should be understood that the same double-sided attachment can be provided on dog leashes as well.

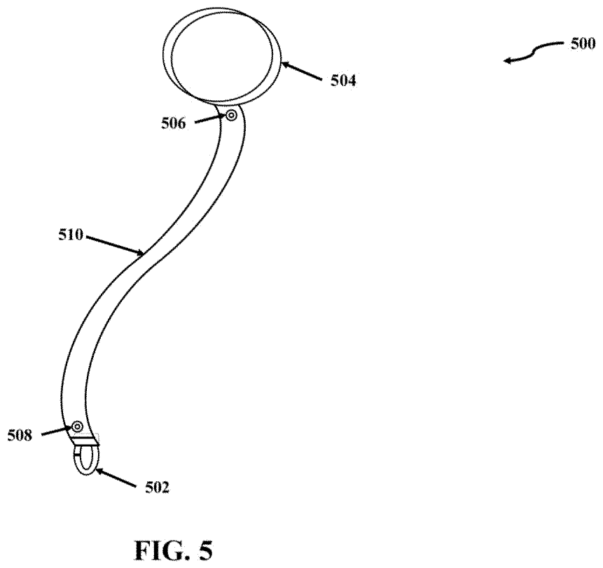

Shown in FIG. 5 is a dog leash 500. The dog leash has a cloth or synthetic material portion 510 having a hand loop 504 on one end and a latch 502 on the other. The latch 502 is configured so that it can be looped onto a dog collar. The dog leash 500 has clip buttons 506 and 508. The clip buttons can be made of plastic or metal.

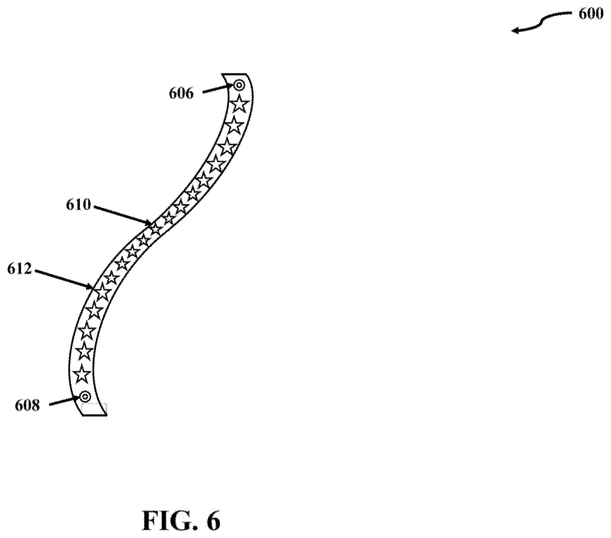

Shown in FIG. 6 is a double-sided attachment for the dog leash. One side is shown, but it should be understood that the double-sided attachment has two sides like the one disclosed for the dog collar in FIG. 2. The double-sided attachment 600 has clip buttons 606 and 608 that allow them to be removably affixed to a dog leash. The clip buttons 608 and 606 can be made of plastic or metal. The double-sided attachment 600 has designs 612.

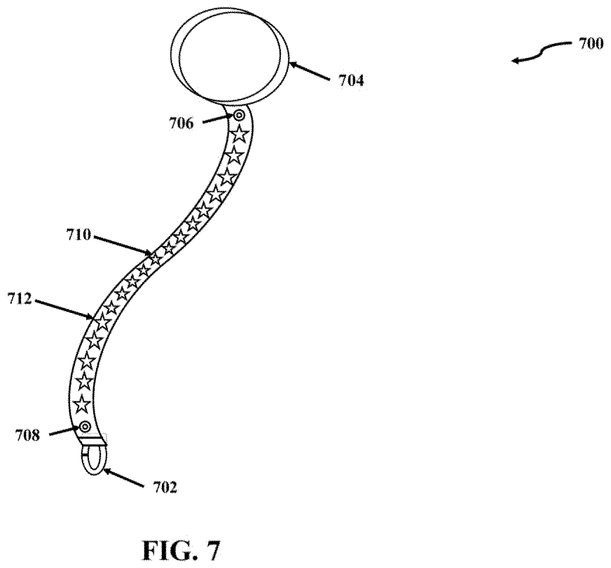

Shown in FIG. 7 is a dog leash of FIG. 5 shown with the double-sided attachment of FIG. 6 attached. The dog leash has a hook 702, and a hand loop 704. The double-sided attachment has been attached via clip buttons so that design 712 is showing. It should be understood that double sided attachment is attached via buttons on the other side of the attachment which are not shown in FIG. 7. Shown are clip buttons 706 and 708, where the double sided attachment can be flipped around and the clip buttons 706 and 708 can be attached to the leash 710.

It should be understood that, although dog collars and leashes are shown, that any type of pet or animal collar is within the scope of the disclosure.

It should be understood that any types of clips or snaps (metal or plastic), magnetic connections, hook and loop (commonly referred to as VELCRO).

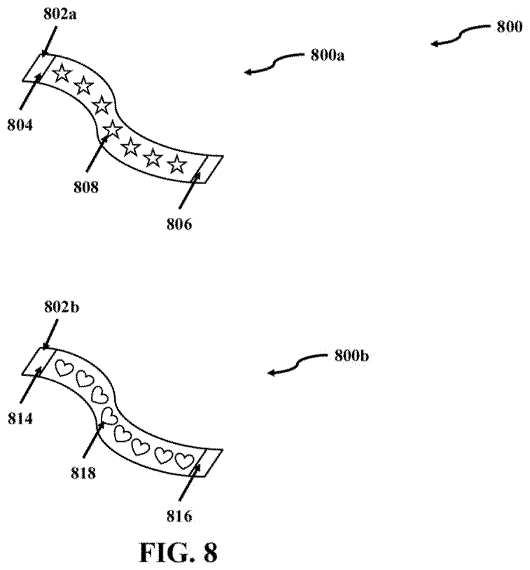

FIG. 8 illustrates a dog collar attachment 800 using a hook and loop system. The dog collar attachment 800 is configured to be two-sided. Shown in 800a is a first side and shown in 800b is the second side. In an embodiment, the dog collar attachment 800 is single sided.

Shown on the first side 800a is a side 802a having a particular design, e.g., stars 808. Attached to side 802a are hook and loop portions 804 and 806. The hook and loop portions 804 and 806 are configured so that they can be removably attached to a dog collar that would have the opposite attachment mechanism. For example, if the dog collar attachment had fabric loops, the dog dollar portion would have hooks, and vise-versa.

Shown in the second side 800b, is a side 802b having a different design, e.g., hearts 818. Attached to side 802b are hook and loop portions 814 and 816. The hook and loop portions 814 and 816 are configured so that they can be removably attached to a dog collar.

As should be appreciated, because the hook and loop portions are arranged at the distal regions of the dog collar attachment, the dog collar attachment can be double sided. That is, if either a hook or loop were arranged along an entire portion of a side, the dog collar attachment would not be able to be double sided, because one side would be covered.

The disclosure provides a dog collar attachment that effectively functions as two entirely separate dog collar attachments. This allows a person to use the dog collar attachment that has two entirely separate designs. For example, a day-time design could be used, and on the other side a night-time design having reflectors could be used on the opposite end.

The components described above are meant to exemplify some types of possibilities. In no way should the aforementioned examples limit the scope of the disclosure, as they are only exemplary embodiments.

While this document contains many specifics, these should not be construed as limitations on the scope of the invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described, and other implementations, enhancements and variations can be made based on what is described and illustrated in this disclosure.

What is claimed is:

1. An attachment comprising:
a piece of a first material, the piece of the first material being substantially the same size as the size of a second material, the first material having a first side that has a first design;
a first attaching mechanism provided on one end of the first side of the piece of first material; and
a second attaching mechanism provided on the other end of the first side of the piece of the first material, wherein the first attaching mechanism and the second attaching mechanism are configured to allow the first material to be removably attached to the second material.

2. The attachment of claim 1, further comprising:
a second side on the first material, the second side having a second design;
a third attaching mechanism provided on one end of the second side of the first material; and
a fourth attaching mechanism provided on the other end of the second side of the first material, wherein the third attaching mechanism and the fourth attaching mechanism are configured to allow the first material to be removably attached to the second material.

3. The attachment of claim 2, wherein the second material is a dog collar.

4. The attachment of claim 2, wherein the second material is a dog leash.

5. The attachment of claim 2, wherein the first design is a reflector.

6. The attachment of claim 2, wherein the first design and the second design are sports team logos.

7. The attachment of claim 2, wherein the first material comprises synthetic material or faux stitching.

8. The attachment of claim 2, wherein the first material is configured so that it covers the second material when: (a) the first attaching mechanism and second attaching mechanism, or (b) the third attaching mechanism and the fourth attaching mechanism, are attached to the second material.

9. The attachment of claim 2, wherein the first, second, third, and fourth attaching mechanisms are metal or plastic clips.

10. The attachment of claim 2, wherein the first, second, third, and fourth attaching mechanisms are either a hook or loop.

11. A pet collar comprising:
a material, the material having attachment mechanisms on each end, the attachment mechanism being configured to removably attach to each other;
a first attaching mechanism on one end of the material; and
a second attaching mechanism on the other end of the material, wherein the first and second attaching mechanism are configured to receive an attachment, the attachment being removably attachable.

12. The pet collar of claim 11, wherein the attachment further comprises a third attaching mechanism on one end of the attachment and a fourth attaching mechanism on the other end of the attachment, the attachment's third and fourth attaching mechanism being configured to be removably attached to the first attaching mechanism and the second attaching mechanism, the attachment having a first design.

13. The attachment of claim 12, wherein the attachment further comprises a fifth attaching mechanism on one end of the attachment and a sixth attaching mechanism on the other end of the attachment, the fifth and sixth attaching mechanism being placed on the other side of the third and fourth attaching mechanism, the attachment's fifth and sixth attaching mechanism being configured to be removably attached to the first attaching mechanism and the second attaching mechanism, the attachment having a second design.

14. The attachment of claim 13, wherein the first design is a reflector.

15. The attachment of claim 13, wherein the second design is a reflector.

16. The attachment of claim 13, wherein the first design and the second design are sports team logos.

17. The attachment of claim 13, wherein the attachment is made of synthetic material or faux stitching.

18. The attachment of claim 13, wherein the first, second, third, fourth, fifth, and sixth attaching mechanisms are a hook or a loop.

19. The attachment of claim 13, wherein the first, second, third, fourth, fifth, and sixth attaching mechanisms are metal or plastic.

20. The attachment of claim 13, wherein material is covered by the attachment when the (a) third and fourth or (b) the fifth and the sixth attaching mechanism are attached to the first and second attaching mechanism.
